(19) United States
(12) Patent Application Publication
(10) Pub. No.: US 2014/0214545 A1
(43) Pub. Date: Jul. 31, 2014

(54) RANKING OF ADVERTISEMENTS FOR DISPLAY ON A MOBILE DEVICE

(71) Applicants: Hao Zhang, Fremont, CA (US); Hong Yan, Mountain View, CA (US)

(72) Inventors: Hao Zhang, Fremont, CA (US); Hong Yan, Mountain View, CA (US)

(21) Appl. No.: 13/756,439

(22) Filed: Jan. 31, 2013

(51) Int. Cl. G06Q 30/02

(52) U.S. Cl. CPC G06Q 30/0267
USPC 705/14.64

(57) ABSTRACT

An online system ranks an advertisement for display on a user's mobile device based on a mobile friendliness score for the advertisement. The mobile friendliness score is calculated using information about the advertisement's landing page, such as feedback received for the landing page. The mobile friendliness score may also reflect additional information, such as information about the user to be presented with the advertisement, parameters of the mobile device on which the advertisement is to be presented, or user feedback associated with the advertisement. Based on the mobile friendliness score, the advertisement is ranked for presentation to the user via the mobile device. A higher ranking may increase the likelihood and/or frequency of presenting the advertisement via the user's mobile device.

### BACKGROUND

This invention relates generally to online systems, and in particular to displaying mobile advertisements on an online system.

Many online systems generate revenue by presenting advertisements to their users. Using online systems to present advertisements allows advertisers to generate interest in products or services from online system users and to increase the likelihood of online system users interacting with content presented in the advertisements. The increasing use of mobile devices (e.g., smartphones, personal digital assistants, etc.) to access online systems provides advertisers with abundant opportunities for presenting advertisements to users accessing online systems.

Conventionally, online systems have displayed the same versions of advertisements to mobile device users to and desktop computer users or have limited display of advertisements on mobile device to those advertisements having a landing page developed for presentation on a mobile device). But this does not take account for factors specific to displaying advertisements on a particular user's mobile device, which may limit effectiveness of advertisements presented to the user by a mobile device. For example, conventional presentation of advertisements via mobile devices does not account for variability in mobile device screen sizes and for personal interests of mobile device users when determining which advertisements to display. Therefore, conventional online systems have not taken full advantage of advertisement presentation using mobile devices.

### SUMMARY

An online system derives revenue by presenting advertisements to its users, which may be presented using mobile devices. To maximize the effectiveness of advertisements presented by mobile devices (“mobile advertisements”), the online system calculates a mobile friendliness score for advertisements and uses the mobile friendliness score to rank advertisements. The mobile friendliness score is calculated based on a variety of factors. Example factors used to calculate the mobile friendliness score include: whether an advertisement is associated with a mobile-friendly landing page, information associated with a user to be presented the advertisement (the “viewing user”), a mobile device associated with the viewing user, implicit and/or explicit user feedback associated with the landing page associated with the advertisements, and other information associated with the landing page. Advertisements with the highest mobile friendliness scores or having at least a threshold mobile friendliness score are prioritized for display to users accessing the online system through a mobile device. This increases the likelihood of users presented with an advertisement using a mobile device will interact with the presented advertisement. The mobile friendliness score may also be used for additional purposes, such as to target audiences for advertisements or to set prices for advertisers to pay for presenting advertisements via the online system.

### BRIEF DESCRIPTION OF THE DRAWINGS

FIG. 1 is a block diagram of a system environment in which an online system operates, in accordance with an embodiment of the invention.

FIG. 2 is a block diagram of an online system, in accordance with an embodiment of the invention.

FIG. 3 is a flow chart of a method for ranking an advertisement for display on a mobile device, in accordance with an embodiment of the invention.

FIG. 4 is a flow chart of an alternative method for ranking an advertisement for display on a mobile device, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

An online system derives revenue from advertisers by presenting advertisements from the advertisement to users of the online system. As users may access the online system through mobile devices, the online system calculates a mobile friendliness score for advertisements and uses the mobile friendliness score to select advertisements for presentation to users accessing the online system via mobile devices. For example, advertisements with higher mobile friendliness scores or with at least a threshold mobile friendliness score are more likely to be served or are more frequently served to users accessing the online system via a mobile device.

The mobile friendliness score for an advertisement is calculated using information associated with a landing page associated with the advertisement, a user to be presented with the advertisement, the user's mobile device, and user feedback (implicit and/or explicit) associated with the landing page. A landing page is a web page, application, web site, or other network destination to which a user is directed when accessing an advertisement. Information associated with a landing page indicates whether there is a mobile version of the landing page or whether there is a native application associated with the landing page. Additionally, information associated with a landing page may specify a user rating for a native application associated with the landing page. Information associated with the user's mobile device includes the operating system of the device, the speed and/or type of network connection used by the mobile device, the screen size of the mobile device, the service provider providing the network connection, or any other suitable information. User-specific information may include declarative, historical, and social information about the user stored by the online system, as well as information about the user's geographic location. User feedback used to calculate the mobile friendliness score of an advertisement may include feedback for a landing page associated with the advertisement or associated with similar advertisements containing the same or similar components (e.g., title, text, image, etc.).

The mobile friendliness scores for advertisements may be used when selecting target audiences for advertisements or for setting prices for advertisements. For example, the online system identifies correlations between users' information and the effectiveness of an advertisement to identify users most likely to interact with an advertisement. In addition, an advertisement having a high mobile friendliness score is be more likely to be displayed or to be displayed more often, so the online system may specify a higher bid price for the advertisement (e.g., cost per impression or cost per click).

### System Architecture

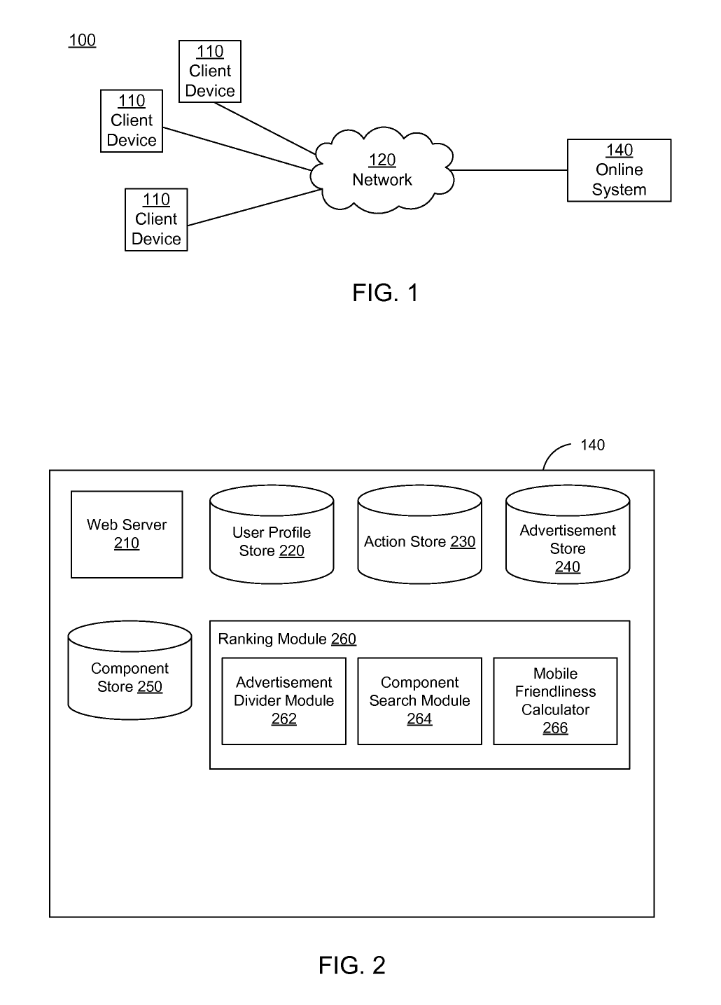

FIG. 1 is a high level block diagram illustrating a system environment 100 for an online system 140. The system environment 100 comprises one or more client devices 110, a network 120, and an online system 140, such as a social networking system. Users and advertisers connect to the online system 140 via client devices 110 through the network 120. In alternative configurations, different and/or additional components may be included in the system environment 100.

The client devices 110 comprise one or more computing devices capable of receiving user input as well as transmitting and/or receiving data via the network 120. In one embodiment, a client device 110 is a conventional computer system, such as a desktop or laptop computer. In another embodiment, a client device 110 may be a device having computer functionality, such as a personal digital assistant (PDA), a mobile telephone, a smart-phone or other similar device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. As another example, a client device 110 interacts with the online system 140 through an application programming interface (API) that runs on the native operating system of the client device 110, such as IOS® or ANDROID™.

The client devices 110 are configured to communicate via the network 120, which may comprise any combination of local area and/or wide area networks, using both wired and wireless communication systems. In one embodiment, the network 120 uses standard communications technologies and/or protocols. Thus, the network 120 may include communication channels using technologies such as Ethernet, 802.11, worldwide interoperability for microwave access (WiMAX), 3G, 4G, code division multiple access (CDMA), digital subscriber line (DSL), etc. Similarly, the networking protocols used on the network 120 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 120 may be represented using technologies and/or formats including hypertext markup language (HTML) or extensible markup language (XML). In addition, all or some of the communication channels may be encrypted using conventional encryption technologies such as secure sockets layer (SSL), transport layer security (TLS), and Internet Protocol security (IPsec).

FIG. 2 is a block diagram of an example architecture of the online system 140. The online system 140 includes a web server 210, a user profile store 220, an action store 230, an advertisement store 240, a component store 250, and a ranking module 260. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

The web server 210 links the online system 140 to the one or more client devices 110, as well as to one or more third party websites, via the network 120. The web server 210 serves web pages, as well as other web-related content, such as JAVA®, FLASH®, XML and so forth. The web server 210 may receive and route messages between the online system 140 and the client device 110, for example, instant messages, queued messages (e.g., email), text and short message service (SMS) messages, or messages sent using any other suitable messaging technique. A user may send a request to the web server 210 for the online system 140 to store information or to retrieve information from the online system 140. Additionally, the web server 210 may provide application programming interface (API) functionality to send data directly to native client device operating systems, such as IOS®, ANDROID™, WEBOS®, or RIM®.

Each user of the online system 140 is associated with a user account, which is typically associated with a single user profile stored in the user profile store 220. A user profile includes declarative information about the user that was explicitly shared by the user, and may also include profile information inferred by the online system 140. In one embodiment, a user profile includes multiple data fields, each data field describing one or more attributes of the corresponding user of the online system 140. Hence information stored in the user profile store 220 describes characteristics of the users of the online system 140, including biographic, demographic, and other types of descriptive information, such as work experience, educational history, gender, hobbies or preferences, location, and any other suitable information. User profile information may also include data describing one or more relationships between a user and other users. Additionally, the user profile store 220 may also store other information provided by the user, for example, images or videos. A user profile in the user profile store 220 may also maintain references to actions performed by the corresponding user and stored in the action store 230.

The online system 140 receives communications about user actions internal to and/or external to the online system 140 and populates the action store 230 with information describing user actions. Examples of actions include: adding a connection to another user, sending a message to another user, uploading an image, reading a message from another user, viewing content associated with another user, attending an event posted by another user, or any other suitable actions. Users may interact with various objects maintained by the online system 140, and these interactions are stored in the action store 230. Examples of interactions with objects stored in the action store 230 include: commenting on posts, sharing links, and checking-in to physical locations via a mobile device or other client device 110. Additional examples of interactions with objects on the online system 140 included in the action store 230 include commenting on a photo album, communicating a message to a user, becoming a fan of a musician, adding an event to a calendar, joining a group, becoming a fan of a brand page, creating an event, authorizing an application, using an application, interacting with an advertisement, and engaging in a transaction.

The advertisement store 240 stores information describing advertisements received by the online system 140 and a ranking of the advertisements based at least in part on the mobile friendliness scores of the advertisements. Examples of information describing advertisements includes whether there is a mobile version of a landing page of an advertisement, user feedback associated with a landing page of an advertisement or for an advertisement itself, targeting criteria defining a target group of users of the online system 140 eligible to receive an advertisement, and any other suitable information. The advertisement store 240 may also include advertisements for which a mobile friendliness score has not been determined. Information describing advertisements may be manually provided through an interface provided by the online system 140, may be received via information from an advertiser, or may be received in any other suitable manner.

The component store 250 stores information describing components of advertisements in the advertisement store 240. Information associating the components with their corresponding advertisements is also maintained by the component store 250. In some embodiments, the component store 250 stores components in their entirety. Alternatively, the component store 250 stores a representation of the components such as a hash or a signature describing a component.

The ranking module 260 determines mobile friendliness scores for advertisements and ranks the advertisements base at least in part on their mobile friendliness scores. In the example shown by FIG. 2, the ranking module 260 includes an advertisement divider module 262, a component search module 264, and a mobile friendliness calculator 266. However, in other embodiments, the ranking module 260 may include different and/or additional components. Additionally, some embodiments of the ranking module 260 may include fewer components than those shown by FIG. 2.

The advertisement divider module 262 partitions an advertisement into one or more components. In one embodiment, the advertisement divider module 262 partitions an advertisement into one or more of a title, a body, an image, a landing page, and an account. The title provides a brief description of the advertisement. The body, or text, of an advertisement provides details about a product, service, or other content associated with the advertisement. The image is graphical data displayed by the advertisement. A landing page, or destination, is a web page, application, web site, or other network destination to which a user is directed when accessing the advertisement. An account identifies an advertiser associated with the advertisement. In other embodiments, advertisements may be partitioned into different and/or additional components.

When determining a mobile friendliness score using a component of an advertisement, the component search module 264 determines whether the component store 250 includes data indicating whether a component matching, or similar to, the component of the advertisement was previously used to calculate a mobile friendliness score. If a match is found, the component search module 264 retrieves the data associated with the matching or similar component, and the mobile friendliness calculator 266 computes a mobile friendliness score based on the retrieved data. For example, if a landing page associated with an advertisement is also associated with an additional advertisement for which a mobile friendliness score was calculated, information associated with the landing page, such as implicit or explicit user feedback associated with the mobile friendliness of the landing page (e.g., the click through rate for a landing page or feedback indicating that the landing page was not easily viewable on a mobile device), is used to compute the mobile friendliness score of the advertisement. A process to determine the similarity between two components is further disclosed in U.S. patent application Ser. No. 13/756,357, filed on Jan. 31, 2013, which is hereby incorporated by reference in its entirety.

### Mobile Friendliness Score Calculation

The mobile friendliness calculator 266 calculates a mobile friendliness score describing the suitability of interacting with an advertisement when it is presented on a mobile device. Information associated with the landing page associated with an advertisement, the user to be presented with the advertisement, the user's mobile device, and user feedback (implicit and/or explicit) associated with the advertisement, as well as any other suitable factors, is used to determine the advertisement's mobile friendliness score. In various embodiments, any suitable combination of information associated with an advertisement may be used to determine a mobile friendliness score for an advertisement.

Examples of information associated with the landing page of an advertisement includes an indication of whether there is a mobile version of the landing page, whether there is a native application for the landing page, and a user rating for the landing page or for the native application for the landing page. In one embodiment, the existence of a mobile version of the landing page or of a native application corresponds to a higher mobile friendliness score. Similarly, in various embodiments, a high user rating for the native application or landing page increases the mobile friendliness score associated with the advertisement.

Information associated with the user's mobile device describes whether a landing page associated with an advertisement is supported by an operating system of the mobile device on which the advertisement is to be displayed (e.g., IOS® or ANDROID™), screen size of the mobile device, network connection used by the mobile device (e.g., Wi-Fi, 3G, 4G, DSL, etc.), and service provider providing the network connection to the mobile device (e.g., AT&T®, VERIZON®, SPRINT®, etc.), or any other suitable information. In one embodiment, an advertisement's mobile friendliness score is higher if the landing page associated with the advertisements is supported by the operating system of the mobile device on which the advertisement is to be presented. Additionally, in some embodiments, the mobile friendliness score of an advertisement depends on one or more of the mobile device screen size, the type of network connection used by the mobile device, and/or the service provider providing the network connection. For example, a larger mobile device screen size or a faster type of network connection increases an advertisement's mobile friendliness score.

User-specific information for calculating a mobile friendliness score may include declarative information retrieved from a user profile associated with the user to be presented with the advertisement (e.g., favorite movies, books, restaurants, etc.), historical information relating to the user's actions (e.g., liking a page post or visiting a web page for a specific brand), social information associated with users connected to the user to be presented with the advertisement (e.g., a rating for an advertisement for a café by a user connected to a user to be presented with the advertisement), as well as information about the user's geographic location. A user's geographic location may be determined, inferred, or predicted from one or more of global positioning system (GPS) information, status updates, messaging information, profile information, internet protocol (IP) address, or other suitable information. For example, the location of a mobile device used by a user is determined from GPS communicated to the online system 140 by the mobile device. As another example, a user's location is inferred based on the user's interactions online system 140, such as being tagged at a location in a photo by other users connected to the user, or checking-in to a specific location. As another example, a user's indication of attendance to an event indicates that the user is likely to be at a location associated with the event during the time of the event.

User feedback is also used to calculate an advertisement's mobile friendliness score. In various embodiments, the user feedback is for the advertisement itself, for similar advertisements, for additional advertisements having the same or similar components (e.g., title, text, image, etc.). The feedback may be implicit (e.g., click through rate) or explicit. Examples of explicit feedback include hiding an advertisement and providing a reason for hiding the advertisement (e.g., indicating that the landing page was too small to see clearly). Additionally, user feedback about the landing page associated with an advertisement may be used when calculating an advertisement's mobile friendliness score.

In some embodiments, the ranking module 260 may use additional information to rank advertisements. For example, the ranking module 260 may rank advertisements based on their mobile friendless score as well as social context information associated with the advertisements. In one embodiment, the ranking module 260 modifies the ranking of advertisements based on affinity scores as well as on mobile friendliness scores. Additional factors may be used to rank the advertisements, such as the expected value to the social networking system 140 of presenting the advertisements, or any other suitable factor. Various combinations of mobile friendliness scores, affinity scores, expected values, or any other suitable information may be used to rank advertisements. Processes using affinity scores to rank advertisements including social context information for presentation to the user are further disclosed in U.S. patent application Ser. No. 13/043,424, filed on Mar. 8, 2011, and U.S. patent application Ser. No. 12/193,702, filed on Aug. 18, 2008, which are hereby incorporated by reference in their entirety.

### Advertisement Ranking

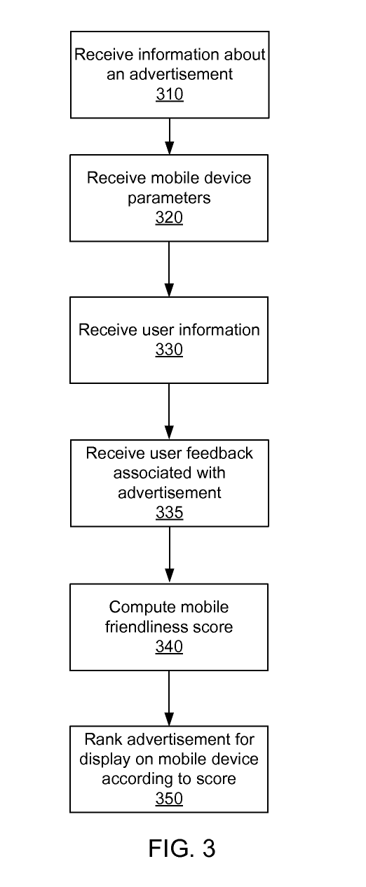

FIG. 3 shows one embodiment of a method for ranking an advertisement based on a mobile friendliness score associated with the advertisement. The online system 140 receives 310 information about an advertisement and communicates the advertisement to the mobile friendliness calculator 266, which also receives 320 information about a mobile device on which the advertisement is to be presented. For example, the mobile friendliness calculator 266 receives 320 information from the mobile device along with a request to present an advertisement via the mobile device. Additionally, the mobile friendliness calculator 266 receives 330 information about the user to be presented with the advertisement. For example, a request to present an advertisement includes user identifying information that the mobile friendliness calculator 266 uses to retrieve a user profile associated with the user from the user profile store 220. Feedback associated with one or more advertisements is received 335 from the advertisement store 240 and/or from the action store 230 and used by the mobile friendliness calculator to compute 340 a mobile friendliness score for the advertisement.

Based on the mobile friendliness score, the advertisement is ranked 350 among additional advertisements for display on the mobile user's mobile device, and an advertisement is selected based at least in part on the ranking. In some embodiments, the advertisement is ranked 350 based on its mobile friendliness score along with other factors, such as social context information associated with the advertisement, expected value of the advertisement, or any other suitable factors. In one embodiment, a higher rank for the advertisement corresponds to a greater likelihood and/or frequency that the advertisement will be displayed. For example, the mobile friendliness calculator 266 may rank a non-mobile advertisement for women's clothing that requires a FLASH® player for presentation and that has received negative user feedback lower than a mobile advertisement for men's clothing that does not require a FLASH® player for presentation and that has received positive user feedback if the retrieved user information indicates that the user to be presented an advertisement is a male and the received mobile device parameters indicate the mobile device for presenting the advertisement does not support FLASH® media.

### Component Ranking

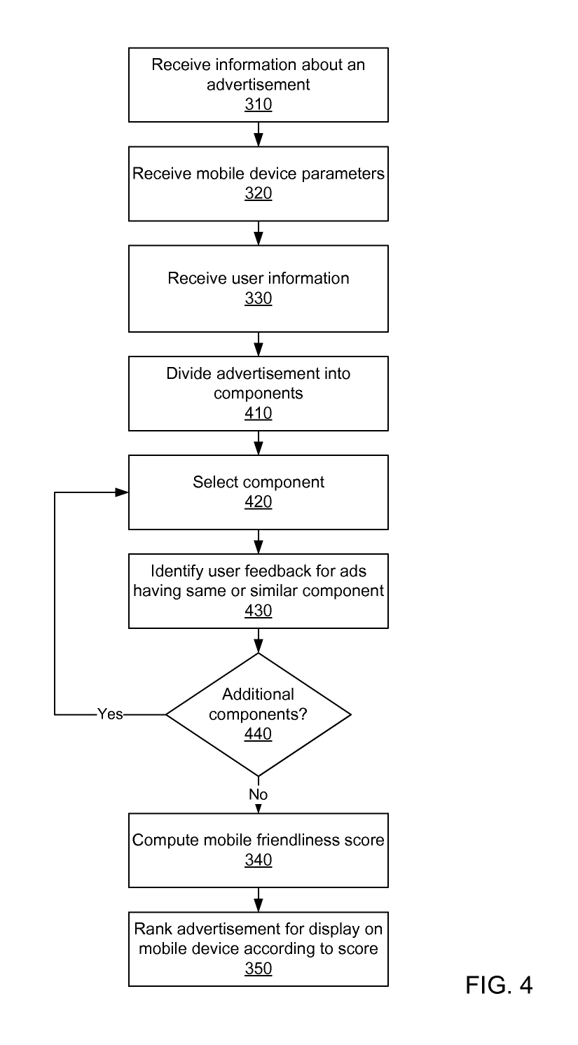

FIG. 4 shows an alternative embodiment of a method for ranking an advertisement based on a mobile friendliness score associated with the advertisement. The online system 140 receives 310 information about an advertisement and communicates the advertisement to the mobile friendliness calculator 266, which also receives 320 information about a mobile device on which the advertisement is to be presented. For example, the mobile friendliness calculator 266 receives 320 information from the mobile device along with a request to present an advertisement via the mobile device. Additionally, the mobile friendliness calculator 266 receives 330 information about the user to be presented with the advertisement. For example, a request to present an advertisement includes user identifying information that the mobile friendliness calculator 266 uses to retrieve a user profile associated with the user from the user profile store 220.

The advertisement divider module 262 divides 410 the advertisement into one or more components, which are further described above in conjunction with FIG. 2. The ranking module 260 selects a component 420, and the component search module 264 identifies 430 user feedback associated with one or more advertisements containing a matching or similar component. For example, user feedback for an advertisement including a component matching the selected component is identified 430. After identifying the user feedback, the component search module determines 440 whether the advertisement includes additional components. If the advertisement includes additional components, another component is selected 430 and user feedback for advertisements having a component matching, or similar to, the other component is identified 430. In one embodiment, component selection continues until all components of the advertisement have been selected. Alternatively, component selection continues until a threshold number of components or until specified components are selected. Based on the identified user feedback, the user information, and/or the mobile device parameters the mobile friendliness calculator 266 computes 340 a mobile friendliness score for the advertisement. As described above in conjunction with FIG. 3, the advertisement is ranked 350 among other advertisements based on the mobile friendliness score. The ranking is used to select an advertisement for presentation to the user via the mobile device.

### Target Audience Selection

In one embodiment, calculation of the mobile friendliness score aids in selection of an advertisement's target audience. For example, the online system identifies correlations between user feedback and user information to identify characteristics of users likely to interact with an advertisement or likely to be receptive to the advertisement. In one embodiment, the online system 140 identifies characteristics of users providing a specified type of feedback for an advertisement (e.g., a minimum rating for the advertisement or its landing page) and analyzes the characteristics to identify one or more common characteristics, such as characteristics common to at least a threshold number of users providing the specified type of feedback. For example, if an advertisement is for a dog grooming service, the online system 140 may determine that the age and gender of users providing positive feedback for the advertisement has common values for at least a threshold number of users providing positive feedback (e.g., 20-30 years old and female). Accordingly, the online system 140 may increase the frequency with which the advertisement is presented to users having the determined values for age and gender both using mobile devices and other computing systems,

### Mobile Advertisement Price Determination

In another embodiment, the online system 140 uses the mobile friendliness score to set the bid price for presentation of an advertisement. For example, if an advertisement receives a high mobile friendliness score, it is more frequently displayed, allowing the online system 140 to specify a higher bid price (e.g., cost per impression or cost per click) for presenting the advertisement. The online system 140 may increase the bid price of an advertisement if the advertisement has at least a threshold mobile friendliness score. For example, the online system 140 charges an advertiser $0.50 for presenting an advertisement having at least the threshold mobile friendliness score and charges the advertiser $0.40 for presentation of an advertisement with a mobile friendliness score less than the threshold.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving, at an online system, information about an advertisement from an advertiser;
determining a landing page to which the advertisement links;
identifying an opportunity to serve the advertisement to a mobile device of a user of the online system;
computing a score for the advertisement, the score comprising a measure of mobile friendliness of the advertisement based at least in part on information associated with the landing page of the advertisement;
ranking the advertisement based at least in part on the computed score, the advertisement ranked along with a plurality of other advertisements;
selecting an advertisement to serve to the mobile device based at least in part on the ranking; and
sending the selected advertisement to the mobile device for display to the user.

2. The method of claim 1, wherein the information associated with the landing page of the advertisement is selected from a group consisting of: a mobile version of the landing page, a native application for the landing page, a user rating for the native application, a user rating for the landing page, and any combination thereof.

3. The method of claim 1, wherein the computed score is further based on user feedback describing the mobile friendliness of the advertisement.

4. The method of claim 3, further comprising:
dividing the advertisement into a plurality of components; and
identifying, for each component of the plurality of components, user feedback describing the mobile friendliness of one or more additional advertisements containing the component.

5. The method of claim 1, wherein the computed score is further based on information describing characteristics of the mobile device of the user of the online system.

6. The method of claim 5, wherein the information describing characteristics of the mobile device of the user is selected from a group consisting of: an operating system, a screen size, a type of network connection, a service provider, and any combination thereof.

7. The method of claim 1, wherein the computed score is further based on information associated with the user of the online system and stored by the online system.

8. The method of claim 1, wherein the advertisement from an advertiser comprises a story associated with content internal to the online system.

9. The method of claim 1, further comprising:
selecting a target audience for the advertisement from an advertiser based at least in part on the computed score.

10. The method of claim 1, further comprising:
determining a bid for presentation of the advertisement based at least in part on the computed score.

11. A method comprising:
retrieving, from an online system, information about an advertisement from an advertiser;
determining a landing page to which the advertisement links;
identifying an opportunity to serve the advertisement to a mobile device of a user of the online system;
computing a score for the advertisement, the score comprising a measure of mobile friendliness of the advertisement based at least in part on information associated with the landing page of the advertisement;
ranking the advertisement based at least in part on the computed score, the advertisement ranked along with a plurality of other advertisements; and
selecting an advertisement to serve to the mobile device based on the ranking.

11. The method of claim 10, further comprising:
sending the selected advertisement to the mobile device for display to the user.

12. The method of claim 11, wherein the information associated with the landing page of the advertisement is selected from a group consisting of: a mobile version of the landing page, a native application for the landing page, a user rating for the native application, a user rating for the landing page, and any combination thereof.

13. The method of claim 10, wherein the computed score is further based on user feedback describing the mobile friendliness of the advertisement.

14. The method of claim 13, further comprising:
dividing the advertisement into a plurality of components; and
identifying, for each component of the plurality of components, user feedback describing the mobile friendliness of one or more additional advertisements containing the component.

15. The method of claim 10, wherein the computed score is further based on information describing characteristics of the mobile device of the user of the online system.

16. The method of claim 15, wherein the information describing characteristics of the mobile device of the user is selected from a group consisting of: an operating system, a screen size, a type of network connection, a service provider, and any combination thereof.

17. The method of claim 10, wherein the computed score is further based on information associated with the user of the online system and stored by the online system selected from a group consisting of: a user profile associated with the user, actions performed by the user on the online system, actions performed by the user external to the online system, information associated with one or more additional users of the online system connected to the user, a geographic location associated with the user, and any combination thereof.

18. The method of claim 10, further comprising:
selecting a target audience for the advertisement from an advertiser based at least in part on the computed score.

19. The method of claim 10, further comprising:
determining a bid for presentation of the advertisement based at least in part on the computed score.
